(19) United States
(12) Patent Application Publication
(10) Pub. No.: US 2008/0236998 A1
(43) Pub. Date: Oct. 2, 2008

(54) CONVEYOR WITH ACCUMULATING SLIP ROLLS

(75) Inventor: Robert Edward Shurko, Farmington Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: DURR SYSTEMS, INC., Plymouth, MI (US)

(21) Appl. No.: 12/055,541

(22) Filed: Mar. 26, 2008

Related U.S. Application Data
(60) Provisional application No. 60/921,056, filed on Mar. 30, 2007.

(51) Int. Cl. B65G 13/00

(52) U.S. Cl. 198/781.02

(57) ABSTRACT

A magnetic accumulating slip roller assembly of a conveyor including a drive axle rotatably driven by a motor, spaced rollers for receiving a skid or other element to be conveyed by the conveyor system supported on the drive axle including a drive roller and an idler roller and a magnetic clutch between the drive roller and the drive axle allowing the drive roller to rotatably slip as the drive axle is rotated by the motor. In the disclosed embodiment, the drive axle is tubular and rotatably supported on a fixed inner axle.

### RELATED APPLICATION

This application claims priority to U.S. Provisional Patent Application Ser. No. 60/921,056 filed Mar. 30, 2007.

### FIELD OF THE INVENTION

This invention relates to magnetic accumulating slip rolls of conveyor systems particularly, but not exclusively, for transporting heavy objects, such as used by the automotive industry for conveying skids having automotive bodies and other components.

### BACKGROUND OF THE INVENTION

Conveyor systems of the type disclosed herein include suspension rollers, including a drive roller and a driven or idler roller which rotatably receive the conveyor skids. In a typical application, the shaft of the roller assembly includes chain sprockets or a belt pulley which receive a chain or belt connected to a motor/motor reducer. The skids, including the conveyed objects, are received on the suspension rollers and are driven by the drive roller and motor. A roller bed of a conventional conveyor is about 20 feet in length and includes a motor/speed reducer driving a plurality of roller assemblies. The skid is then delivered or transferred from one roller bed to the next as the skid is conveyed the length of the conveyor. In a typical application where the skid is about 17 feet in length, each roller bed has about three feet of wasted length. Further, for example, where the conveyor run or delivery lane is 150 feet, the conveyor system must include seven roller beds and seven motors. Further, a conventional conveyor cannot transition directly to a slow speed without using multi-speed drive systems.

### SUMMARY OF THE INVENTION

As set forth above, this invention relates to a magnetic accumulating slip roller assembly of a conveyor system which allows unit or skid accumulation on a roller bed conveyor system. The slip roller assembly of this invention also allows the conveyed units or skids to transition directly to slow speed process cells without using a complex and expensive multi-speed drive system. Further, the magnetic accumulating slip roller assembly of this invention is more robust and more tolerant to installation error and less expensive than conventional roller assemblies as discussed further below.

The magnetic accumulating slip roller assembly of this invention includes an axle rotatably driven by a motor, spaced rollers for receiving a conveyed unit, such as a skid, rotatably supported on the axle, including a drive roller and an idler or driven roller, and a magnetic clutch between the drive roller and the shaft allowing the drive roller to rotatably slip as the shaft is rotated by the motor and the skids to accumulate on the conveyor.

In one preferred embodiment of the slip roller assembly of this invention, the drive axle is tubular and rotatably supported on a fixed inner axle. In this embodiment, the drive axle is rotatably supported on the fixed inner axle by bearings and the ends of the fixed inner axle may be attached to the side frames of the conveyor system by suitable fasteners. Further, in one preferred embodiment, the magnetic clutch includes an annular inner magnetic clutch assembly surrounding and fixed to the axle and an annular outer magnetic clutch fixed to the drive roller surrounding the inner magnetic clutch in close proximity, such that the drive roller rotates with the drive shaft to transfer or convey skids supported on the rollers. However, when a first skid abuts a second skid which is stopped or moving at a slower speed on the conveyor, the magnetic clutch of the roller assembly supporting the first skid slips and reduces or stops movement of the first skid without damage to the first skid. Thus, a conveyor system having the magnetic accumulating slip roller assembly of this invention may convey skids in abutting relation, reducing or eliminating wasted conveyor space and reducing damage to the skids. Further, a conveyor having the magnetic accumulating slip roller assemblies of this invention results in a significant savings in cost. For example, a conveyor having a 150 foot run requires only two motors.

### BRIEF DESCRIPTION OF THE DRAWINGS

FIG. 1 is a top perspective view of one embodiment of a magnetic accumulating slip roller assembly of this invention;

FIG. 2 is a cross-sectional view of FIG. 1 in the direction of view arrows 2-2; and

FIG. 3 is a top perspective view of a portion of a conveyor assembly including the magnetic accumulating slip roller assemblies shown in FIGS. 1 and 2.

### DESCRIPTION OF A PREFERRED EMBODIMENT

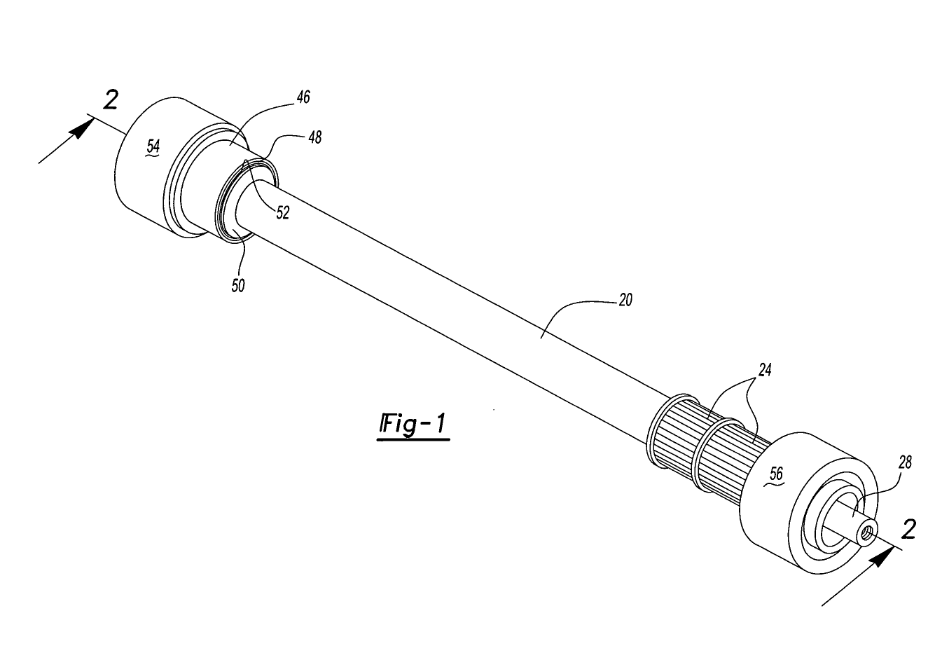

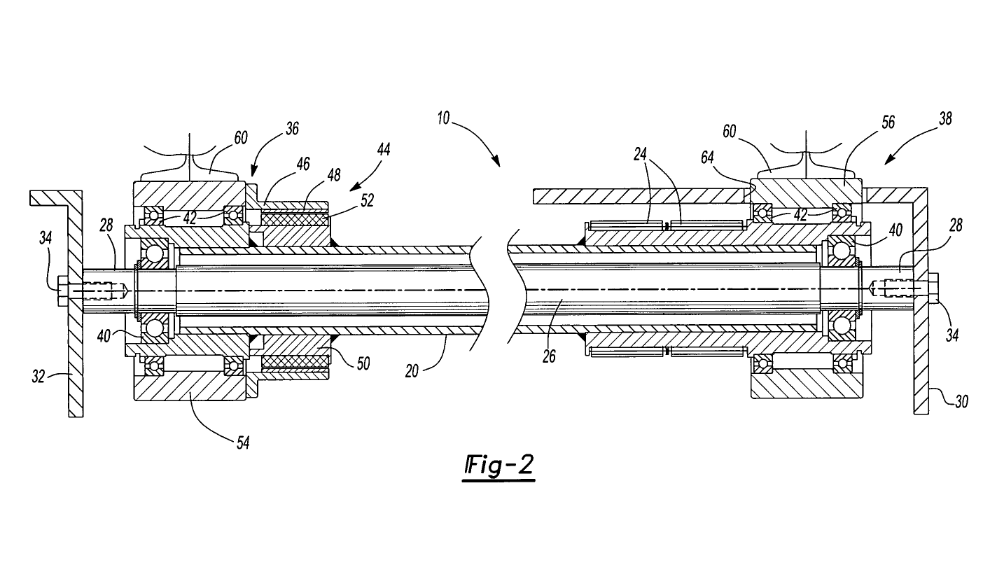

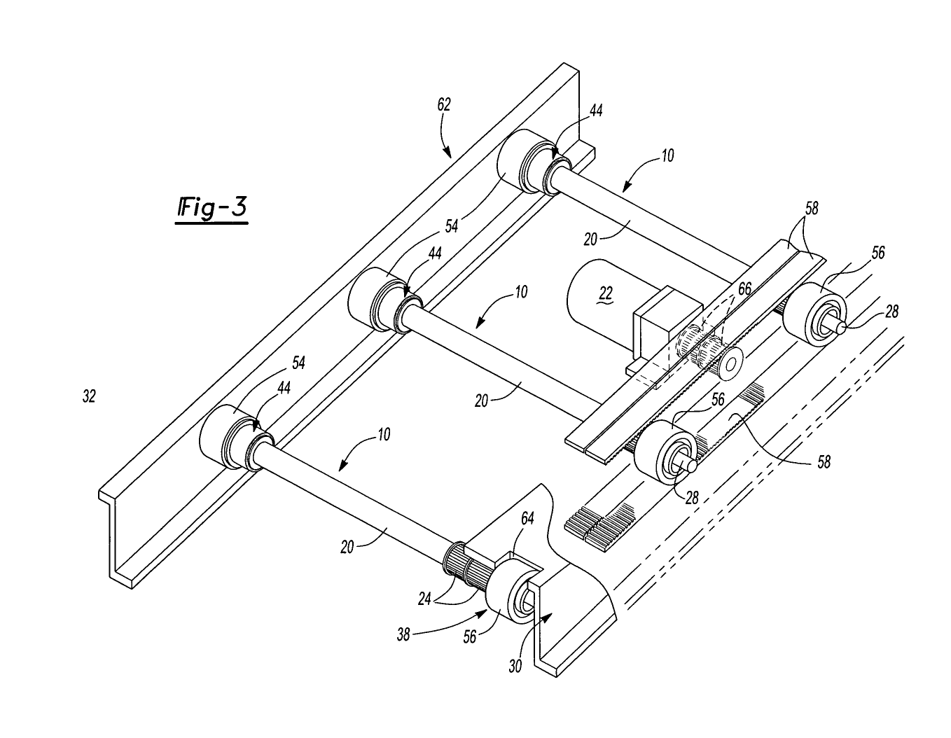

The embodiment of the magnetic accumulating slip roller assembly 10 shown in FIGS. 1 and 2 includes a drive axle 20 which, in the disclosed embodiment, is tubular as shown in FIG. 2. The drive axle 20 in the disclosed embodiment is driven by a motor 22 shown in FIG. 3 and described below. In this embodiment, the drive axle includes splined pulleys 24 which receive splined drive belts 58 as shown in FIG. 3 and described below. As will be understood by those skilled in this art, the pulleys 24 may be replaced with sprockets (not shown) and the accumulating slip roller assembly will then be driven by drive chains.

In the disclosed embodiment, the accumulating slip roller assembly 10 further includes a fixed inner axle 26 which is fixed to and supported on the frame assembly members 30 and 32 as shown in FIG. 2. In the disclosed embodiment, the fixed inner axle 26 includes end portions 28 which are retained to the frame members 30 and 32 by screws 34.

The accumulating slip roller assembly of this invention includes a drive roller assembly 36 and a driven or idler roller assembly 38 which, in the disclosed embodiment, are located at opposed ends of the drive axle 20. The drive roller assembly and driven roller assembly 36 and 38, respectively, include an inner bearing support or bearing race 40 and an outer bearing support or bearing race 42 as shown in FIG. 2. The drive roller assembly 36 further includes a magnetic clutch assembly 44 as shown in FIG. 2. The magnetic clutch assembly includes an outer magnetic clutch assembly 46 having an annular magnet 48 and an inner clutch assembly 50 having an inner magnet 52. As shown in FIG. 2, the annular outer and inner magnets 48 and 52, respectively, are coaxially aligned and in close proximity, creating a hysteresis effect. The drive and driven roller assemblies 36 and 38, respectively each has an outer bearing member 54 and 56, respectively, which receive a skid member 60 or other article supported on and conveyed by the conveyor 62 shown in FIG. 3.

The conveyor assembly 62 partially shown in FIG. 3 includes a plurality of parallel accumulating slip roller assemblies 10 described above rotatably supported on the frame members 30 and 32 as also described above. In this embodiment, the frame member 30 forms a protective enclosure which includes openings 64 which receive the outer bearing member 56 of the driven roller assembly 38 as shown in FIGS. 2 and 3. The motor or motor and speed reducer 22 includes splined pulleys 66 on the drive shaft of the motor 22, which drives the drive belts 66 which are also received by the splined pulleys 24 of the accumulating slip roller assemblies 10, driving the outer bearing members 54 and 56 of the accumulating slip roller assemblies 10 and a skid or other article supported on the outer bearing members and conveying the skids or other elements along the conveyor. However, when a first skid abuts a second skid which is stopped or moving at a slower speed on the conveyor, the magnetic clutch assemblies 44 reduces or stops movement of the first skid without damage. Thus, the magnetic accumulating slip roller assemblies 10 of this invention may convey skids or other articles in spaced or abutting relation on the conveyor, reducing or eliminating wasted conveyor space and reducing damage to the conveyor or skids. Further, a conveyor having the magnetic accumulating slip roller assemblies 10 of this invention results in a significant savings in cost.

As will now be understood from the above description of a magnetic accumulating slip roller assembly 10 of a conveyor system of this invention, the magnetic slip roller assembly may be utilized to accommodate a plurality of skids received on the outer bearing members or rollers 54 and 56 without damage to the conveyor or the skids. The conveyor system is quieter than conventional systems of this type and allows the skids or units to transition directly to a slower speed without using multi-speed drive systems. The magnetic accumulating slip roller assembly 10 of a conveyor system of this invention is also more robust, more tolerant to installation errors, and less expensive than conventional conveyor systems of this type. Another advantage of the magnetic accumulating roller assembly of this invention is that the roller assembly of this invention may be substituted for conventional roller assemblies without modification to the conveyor.

Having described one embodiment of the magnetic accumulating slip roller assembly for a conveyor system of this invention, it will be understood that various modifications may be made to the disclosed embodiment within the purview of the claims, which follow.

1. A magnetic accumulating slip roller assembly of a conveyor system, comprising:
a drive axle rotatably driven by a motor, spaced rollers for receiving a skid rotatably supported on said drive axle, including a drive roller and an idler roller; and
a magnetic clutch located between said drive roller and said drive axle allowing said drive roller to rotatably slip as said drive axle is rotated by said motor.

2. The magnetic accumulating slip roller assembly of a conveyor system as defined in claim 1, wherein said drive axle is tubular and rotatably supported on a fixed inner axle.

3. The magnetic accumulating slip roller assembly of a conveyor system as defined in claim 2, wherein said drive axle is rotatably supported on said fixed inner axle by roller bearings.

4. The magnetic accumulating slip roller assembly of a conveyor system as defined in claim 1, wherein said magnetic clutch includes an annular inner magnetic clutch fixed to said drive axle and an annular outer magnetic clutch fixed to said drive roller surrounding said inner magnetic clutch.

5. A magnetic accumulating slip roller assembly of a conveyor system, comprising:
a fixed inner axle supported at its opposed ends to a frame assembly of said conveyor system;
a tubular drive axle coaxially aligned with and surrounding said fixed inner axle;
a driven roller assembly having an outer roller bearing surrounding and fixed to said tubular drive axle driven by a motor; and
a drive roller assembly including an outer roller bearing member rotatably supported on said tubular drive shaft and a magnetic clutch located between said tubular drive axle and said outer roller bearing member allowing said drive roller assembly to slip as said drive axle is rotated by said motor.

6. The magnetic accumulating slip roller assembly of a conveyor system as defined in claim 5, wherein said tubular drive axle is rotatably supported on said fixed inner axle by roller bearings.

7. The magnetic accumulating slip roller assembly of a conveyor system as defined in claim 5, wherein said magnetic clutch includes an annular inner magnet fixed to said drive axle and an outer annular magnet fixed to said outer roller bearing surrounding and axially aligned with said inner magnet in close proximity.
